(19) United States
(12) Patent Application Publication
(10) Pub. No.: US 2005/0254928 A1
(43) Pub. Date: Nov. 17, 2005

(54) Methods and apparatuses for movement of cargo

(75) Inventors: Walter John Budd, Rochester, MI (US); Timothy David Sherbeck, Katy, TX (US)

Correspondence Address: FULBRIGHT & JAWORSKI L.L.P., 600 CONGRESS AVE., SUITE 2400, AUSTIN, TX, 78701, US

(73) Assignee: Stewart & Stevenson Services, Inc.

(21) Appl. No.: 11/060,632

(22) Filed: Feb. 17, 2005

Related U.S. Application Data
(60) Provisional application No. 60/545,327, filed on Feb. 17, 2004.

(51) Int. Cl. B60P 1/02

(52) U.S. Cl. 414/543

(57) ABSTRACT

Techniques for loading and/or unloading cargo. A vehicle platform is rotated so that it is positioned between front and rear tires of the vehicle. The platform is lowered to a height lower than a top of the front or rear tires. Cargo is loaded or unloaded using the lowered platform.

This patent application claims priority to, and incorporates by reference in its entirety, U.S. Provisional Patent Application Ser. No. 60/545,327 filed on Feb. 17, 2004.

### BACKGROUND OF THE INVENTION

1. Field of the Invention

The present invention relates generally to the loading and/or unloading of cargo to and/or from a location. For example, the present provides for methods and apparatuses for loading and/or unloading cargo from for example, an aircraft or the ground.

2. Description of Related Art

Currently, apparatuses and methods used for loading and/or unloading cargo to and/or from an aircraft may be inefficient because they intermediate handling equipment to effectuate the loading and/or unloading. Furthermore, current methods and apparatuses for loading and/or unloading are not easily adaptable to different height levels and grade variations, fail to provide the needed load, flexibility, and maneuverability capabilities in one dedicated vehicle, and fail to provide a solution in a size and weight efficient manner.

Several situations require that cargo be loaded to and unloaded from an airplane. For example, in military applications, it is desirable to use a truck to load and unload cargo airplanes. Conventional trucks, however, suffer from several drawbacks. One example limitation is that conventional trucks often must rely on a platform or other structure between it and the cargo airplane to facilitate loading and unloading. Additionally, the beds of conventional trucks cannot offer a full range of motion that would allow for quick, efficient loading and loading. This inability becomes particularly problematic when trucks are being loaded or unloaded to and from a cargo plane while under enemy fire, making efficiency of utmost importance.

It is believed that several problems associated with conventional trucks stem from at least their inability to use beds or platforms that offer a more complete range of motion such as tilting, rotating, and lifting. It would therefore be advantageous to provide an improved loading and/or unloading technique.

### SUMMARY OF THE INVENTION

In one respect, the invention involves a vehicle. The vehicle has two or more front tires and two or more rear tires. The vehicle includes a rotatable platform that is configured to be lowered between the front and rear tires to a height lower than a top of the front or rear tires. In a preferred embodiment, the platform is first rotated such that the platform becomes positioned between the front and rear tires. The platform is then lowered in a level or non-level state to assist with cargo loading and/or unloading. In a preferred embodiment, the lowered platform is used to load and/or unload a cargo aircraft. The platform may be configured to rotate approximately 90 degrees before the platform is lowered. The platform may be a half platform. The platform may include a first and second portion, and the second portion may be configured to be lowered to a height lower than a top of the front or rear tires. The platform may be configured to tilt. The platform may be configured to be leveled such that the platform becomes substantially parallel to a surface, which may be a C-130 aircraft's loading platform's surface. The platform may be configured to be lowered to a height substantially equal to that of a loading platform of a C-130 aircraft. The vehicle may also include a crane configured to load or unload cargo.

In another respect, the invention involves a method. A vehicle platform is rotated so that the platform is positioned between front and rear tires of the vehicle. The platform is lowered to a height lower than a top of the front or rear tires. Cargo is loaded or unloaded to or from the vehicle using the lowered platform. The platform may be rotated approximately 90 degrees. The platform may be a half platform. The platform may include a first and second portion, and the second portion may be lowered to a height lower than a top of the front or rear tires. The method may also include tilting the platform. The method may also include leveling the platform so that it becomes substantially parallel to a surface, which may be a C-130 aircraft's loading platform's surface. The platform may be lowered to a height substantially equal to that of a loading platform of a C-130 aircraft. The method may also include using a crane coupled to the vehicle to assist in the loading or unloading of cargo.

Other features and associated advantages will become apparent with reference to the following description and the attached materials.

The use of the word “a” or “an” when used in conjunction with the term “comprising” in the claims and/or the specification may mean “one,” but it is also consistent with the meaning of“one or more,” “at least one,” and “one or more than one.” The term “coupled” is defined as connected, although not necessarily directly, and not necessarily mechanically.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention as defined in the claims, and the invention includes all such substitutions, modifications, additions and/or rearrangements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows a diagram of a truck for loading and/or unloading cargo, in accordance to an embodiment of the invention.

FIG. 2 shows a diagram of a truck with a rotatable platform, in accordance to an embodiment of the invention.

FIG. 3 shows a diagram of a truck with a tiltable platform, in accordance to an embodiment of the invention.

FIGS. 4A and 4B show diagrams of a truck comprising a sliding platform and crane, in accordance to an embodiment of the invention.

FIG. 5 shows a diagram of a truck with a plurality of platforms, in accordance to an embodiment of the invention.

FIG. 6 shows a diagram of a truck unloading cargo, in accordance to an embodiment of the invention.

### DESCRIPTION OF ILLUSTRATIVE EMBODIMENTS

Embodiments of the present invention provide for efficient techniques for cargo delivery at multiple height levels and that can adapt to grade differences using a controllable suspension. In some embodiments, a cargo truck may be used that includes rotating bed, or platform, and a controllable suspension that can lift and lower the platform. The cargo may include, but is not limited to, containers, military cargo, construction equipment, supplies, or other material.

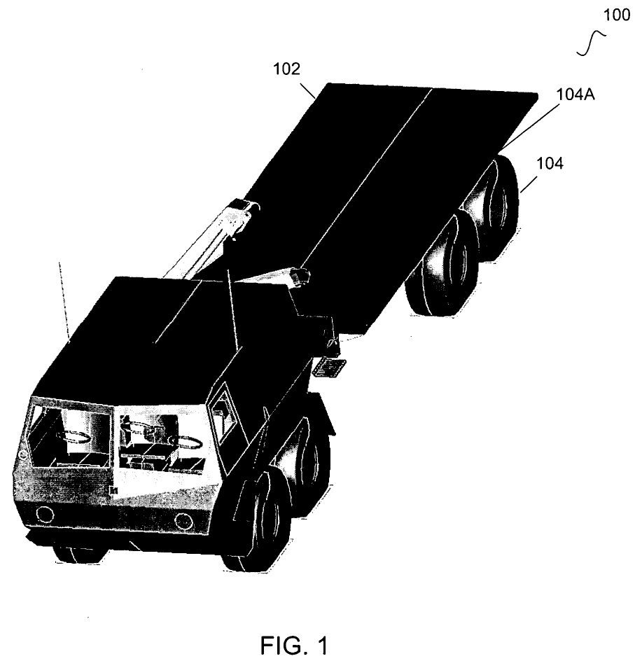

Referring to FIG. 1, truck 100, according to an embodiment of the present invention, is shown. Truck 100 may include platform 102 which may be used to transport cargo to and/or from a location. Platform 102 may be lowered to a height lower than the top (denoted “104A” in FIG. 1) of tires 104. In some embodiments, platform 102 may be lowered by a hydraulic system, such as a piston-cylinder actuator described in U.S. Pat. No. 4,995,783 to Pettito et al., incorporated herein by reference. Alternatively, platform 102 may be lowered by a pneumatic bellows and an air reservoir, as described in U.S. Pat. No. 6,537,017 to Robert M. Stone, which is incorporated herein by reference. The platform may also be lowered by suspension system, springs, chain drives, or electronic machineries. Additionally, a crane coupled to platform 102 may be used to lower the platform. In other embodiments, platform 102 may be rotated and/or tilted, as discussed below.

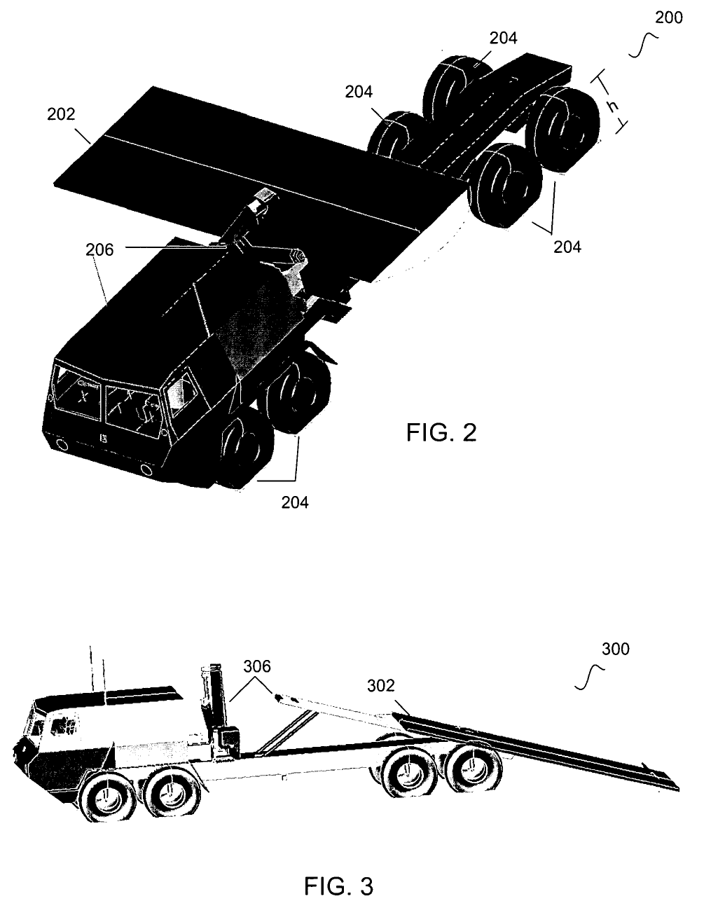

In one embodiment, to lower platform 202, the platform may be rotated to about 90 degrees which allows the crane to reach all parts of the platform, as shown in FIG. 2. A motor, coupled to the platform may be used to rotate and raise/lower the platform to a desired height. It is noted that other means may be used to move the platform, including but not limited to a hydraulic system, a chain operated machinery, air cylinders, ring and pinion gear, etc. Next, the platform may be lowered into a space between the cab of truck 200 and tires 204 by controllable suspension system 206, such that the platform may be lowered to a height that is less than the height of the tires (denoted “h” in FIG. 2). In other words, platform 202 is lowered between front and back tires such that the platform is lower than the top of the front and/or back tires. It is noted that the platform may be lowered to any height between the tires' top and bottom. Alternatively, the platform may be lowered to a position which is flush against a surface, such as an airplane cargo bed, the ground, etc. Further, the platform may also be leveled to be parallel to any surface. The suspension of each tire may be adjusted, such that the tire can be raised or lowered in a vertical direction to accommodate surfaces on an incline such that the platform is substantially parallel to a surface. Alternatively, controllable system 206 which may include a motor, a hydraulic system, a chain operated machinery, air cylinders, or ring and pinion gear, or any combination thereof, may lower and adjust the platform such that the platform is substantially parallel to any surface.

In another embodiment, platform 302 may be tilted off the cab of truck 300 to a height that is below the top of the rear tires, as shown in FIG. 3. Controllable suspension 306 may lift a distal end of platform 302 and slide the platform such that the other distal end may be in contact with a surface lower than the height of the tires. In one embodiment, the surface may be the ground. The platform may be lowered such that one distal end is in contact with the ground and where an acute angle may be formed by the ground and platform 102. It is noted that the surface may be any type of surface including, but not limited to, another delivery utility such as a cargo bed of plane, storage crates, pallets, dollys, etc.

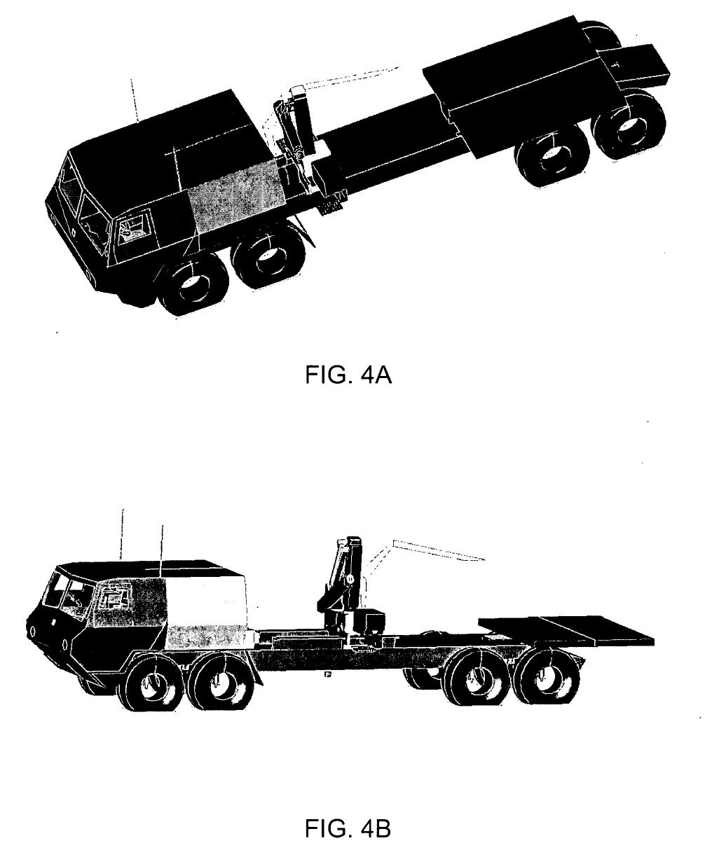

Alternatively, referring to FIGS. 4A and 4B, truck 400 may include a half-platform 402. A half-platform, as described and illustrated in this embodiment, may be a platform that may not extend the entire length of the truck bed. Slide crane 206 may operably slide the half-platform to a distal end of truck 400. In some embodiments, half-platform 402 may extend over a portion of the truck at a height lower than the top of the rear tires to easily access the cargo on the platform. Half platform 402 may be lowered, between front and rear tires, to a height lower than the top of either or both of the front or rear tires.

In another embodiment, a truck may include platform 502A as separate, smaller portion of a bigger platform 502. When platform 502A is lowered to a height that is lower than a top of the rear tire, without having to first rotate, it may be lowered into a space between the cab of the truck and the rear tires.

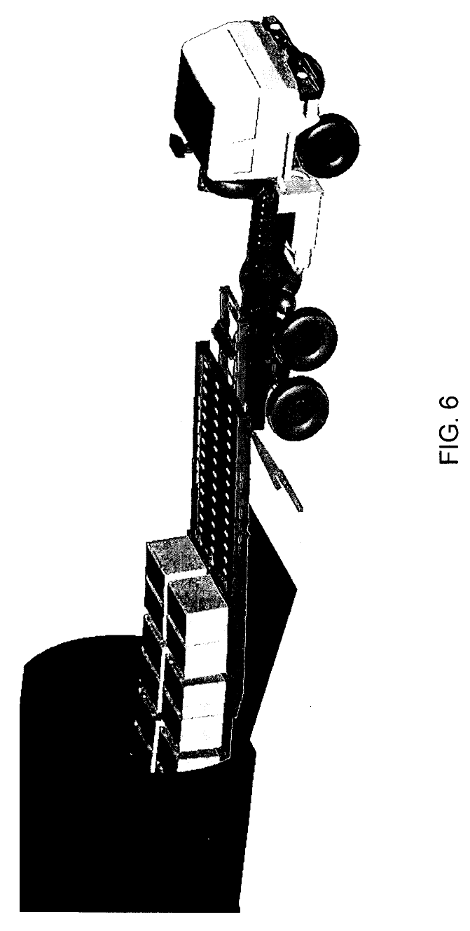

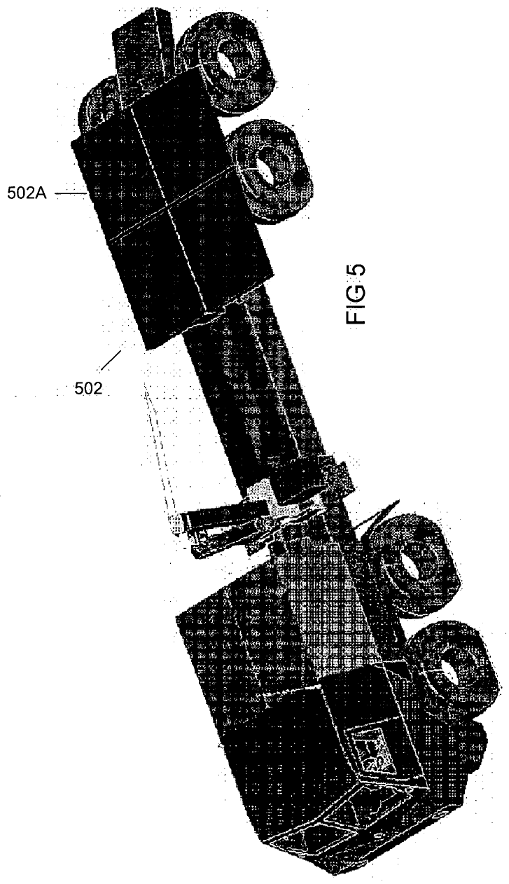

In each of the above embodiments, the truck may be used to load and unload cargo to and from an aircraft, such as a C-130, as shown in FIG. 6. The bed height of a C-130 is approximately 38 inches in height, where most tires on a truck have a diameter of approximately 42 to 46 inches. As such, in order to load and unload cargo, an intermediate vehicle is needed. The present invention, in different embodiments, may eliminate this need by allowing a platform to lower into the region between front and rear tires to a height lower than the front and/or rear tires.

All of the methods disclosed and claimed here can be made and executed without undue experimentation in light of the present disclosure. While the apparatus and techniques of this invention have been described in terms of preferred embodiments, it will be apparent to those of skill in the art that variations may be applied to the methods and in the steps or in the sequence of steps of the method described here without departing from the concept, spirit and scope of the invention. In addition, modifications and substitutions may be made where the same or similar results would be achieved. All such modifications and substitutions apparent to those of ordinary skill in the art are deemed to be within the spirit, scope and concept of the invention as defined by the appended claims.

### REFERENCES

Each of the following references is incorporated by reference in its entirety into this disclosure:
U.S. Pat. No. 3,829,063
U.S. Pat. No. 4,682,926
U.S. Pat. No. 4,995,783
U.S. Pat. No. 5,011,362
U.S. Pat. No. 5,044,858
U.S. Pat. No. 5,816,765
U.S. Pat. No. 5,263,807
U.S. Pat. No. 5,490,758
U.S. Pat. No. 6,537,017

1. A vehicle comprising:
two or more front tires;
two or more rear tires; and
a rotatable platform configured to be lowered between the front and rear tires to a height lower than a top of the front or rear tires.

2. The vehicle of claim 1, where the platform is configured to rotate approximately 90 degrees before the platform is lowered.

3. The vehicle of claim 1, where the platform comprises a half platform.

4. The vehicle of claim 1, where the platform comprises a first and second portion, and the second portion is configured to be lowered to a height lower than a top of the front or rear tires.

5. The vehicle of claim 1, where the platform is configured to tilt.

6. The vehicle of claim 1, where the platform is configured to be leveled such that the platform becomes substantially parallel to a surface.

7. The vehicle of claim 6, the surface comprising a C-130 aircraft's loading platform's surface.

8. The vehicle of claim 1, where the platform is configured to be lowered to a height substantially equal to that of a loading platform of a C-130 aircraft.

9. The vehicle of claim 1, the vehicle further comprising a crane configured to load or unload cargo.

10. A method comprising:
rotating a vehicle platform so that the platform is positioned between front and rear tires of the vehicle;
lowering the platform to a height lower than a top of the front or rear tires; and
loading or unloading cargo to or from the vehicle using the lowered platform.

11. The method of claim 10, where the platform is rotated approximately 90 degrees.

12. The method of claim 10, where the platform comprises a half platform.

13. The method of claim 10, where the platform comprises a first and second portion, and the second portion is lowered to a height lower than a top of the front or rear tires.

14. The method of claim 10, further comprising tilting the platform.

15. The method of claim 10, further comprising leveling the platform so that it becomes substantially parallel to a surface.

16. The method of claim 15, the surface comprising a C-130 aircraft's loading platform's surface.

17. The method of claim 10, where the platform is lowered to a height substantially equal to that of a loading platform of a C-130 aircraft.

18. The method of claim 10, further comprising using a crane coupled to the vehicle to assist in the loading or unloading of cargo.
